(19) United States
(12) Patent Application Publication
(10) Pub. No.: US 2023/0417255 A1
(43) Pub. Date: Dec. 28, 2023

(54) Centrifugal Compressor, and Method for Manufacturing Same

(71) Applicant: Hitachi Industrial Products, Ltd., Chiyoda-ku, Tokyo (JP)

(72) Inventors: Yuta MOCHIZUKI, Tokyo (JP); Takahiro NISHIOKA, Tokyo (JP); Kiyotaka HIRADATE, Tokyo (JP); Kazuhiro TSUKAMOTO, Tokyo (JP)

(21) Appl. No.: 18/036,851

(22) PCT Filed: Oct. 27, 2021
(86) PCT No.: PCT/JP2021/039638

§ 371 Date: May 12, 2023

(30) Foreign Application Priority Data
Dec. 22, 2020 (JP) 2020-212725

(51) Int. Cl. F04D 29/44; F04D 17/12; F04D 29/62

(52) U.S. Cl. CPC F04D 29/444; F04D 17/12; F04D 29/624

(57) ABSTRACT

In the centrifugal compressor, the return channel is provided between a hub-side wall surface and a shroud-side wall surface. The return channel includes a front set of vanes arranged in a circular array on the upstream side and a rear set of vanes arranged in a circular array on the downstream side. The front set of vanes and the rear set of vanes are both formed on the shroud-side wall surface. The front set of vanes is formed on an annular member that is formed separately from the rear set of vanes. The annular member is fitted to the return channel. According to the above, it is possible to improve the tangential velocity component removal ability of front and rear vanes provided in the return channel of a centrifugal compressor.

### TECHNICAL FIELD

The present invention relates to a centrifugal compressor and a method for manufacturing the centrifugal compressor.

### BACKGROUND ART

A centrifugal compressor includes: a centrifugal impeller rotated to give energy to fluid; a diffuser converting kinetic pressure of the fluid having increased pressure, into static pressure; a return channel provided with return vanes configured to remove tangential velocity components of the fluid; and the like.

When fluid passes through the return channel, the fluid flows through between the return vanes arranged at regular intervals in the circumferential direction around the central axis of a rotation shaft, whereby removing tangential velocity components of the fluid. However, it is typically known that insufficient removal of tangential velocity components of fluid leads to reduction in compression efficiency of the impeller of the next stage and its fall in pressure rise.

As a return vane structure to efficiently redirect the flow and remove tangential velocity components of the fluid to straighten the flow, the structure of Patent Literature 1 is proposed.

Patent Literature 1 discloses a tandem return vane structure that includes return vanes (hereinafter, referred to as front vanes) arranged on the upstream side and swirl removal members (rear vanes) arranged on the downstream side. Specifically, Paragraphs No. 0047 and No. 0053 disclose that the swirl removal members (rear vanes) are joined to a wall surface on the shroud side or a wall surface on the hub side.

### CITATION LIST

### Patent Literature

Patent Literature 1: JP2018-178769A

### SUMMARY OF INVENTION

### Technical Problem

According to the technique described in Patent Literature 1, the front vanes are directly joined to the hub- or shroud-side wall surface where the rear vanes are formed.

However, the joining process requires a route for a welding rod or the like to be inserted from radially outside or inside the hub-side wall surface or shroud-side wall surface. In particular, it is difficult for the welding rod to reach between the front vanes and the rear vanes through gaps at the outer or inner circumference when the hub-side wall surface and the shroud-side wall surface face each other with the front and rear vanes interposed therebetween. The applicant had therefore previously designed the shape and layout of the front and rear vanes so as to avoid joining failure. However, the front and rear vanes designed as such had poor ability (hereinafter, also referred to as “a tangential velocity component removal ability”) to remove tangential velocity components of fluid.

The same applies to the structure in which the front and rear vanes are cut out of the hub-side or shroud-side wall surface.

The present invention was made in the light of the aforementioned circumstances, and an object thereof is to improve the tangential velocity component removal ability of the front and rear vanes provided in the return channel of a centrifugal compressor.

### Solution to Problem

To solve the above problems, the present invention provides a centrifugal compressor including a rotation shaft, plural centrifugal impellers, a diffuser, and a return channel. The plural centrifugal impellers are mounted on the rotation shaft. The diffuser causes fluid exiting one of the centrifugal impellers to flow in a centrifugal direction from the rotation shaft. The return channel is provided downstream of the diffuser and causes the fluid flowing from the diffuser to the centrifugal impeller of the subsequent stage to flow in a return direction toward the rotation shaft. The return channel is provided between a hub-side wall surface and a shroud-side wall surface. The return channel includes a front set of vanes arranged in a circular array on the upstream side and a rear set of vanes arranged in a circular array on the downstream side. The front set of vanes and the rear set of vanes are both formed on one of the hub-side wall surface or the shroud-side wall surface. One of the front set of vanes or the rear set of vanes is formed on an annular member that is formed separately from the other one of the front set of vanes or the rear set of vanes. The annular member is fitted to the return channel.

A method for manufacturing a centrifugal compressor according to the present invention includes a formation step, a joining step, and a fitting step. In the formation step, one of a front set of vanes or a rear set of vanes is formed on an annular member formed separately from the other one of the front set of vanes or the rear set of vanes. The front set of vanes is arranged in a circular array on the upstream side in a return channel provided between a hub-side wall surface and a shroud-side wall surface. The rear set of vanes is arranged in a circular array on the downstream side. In the joining step, the other one of the front set of vanes or the rear set of vanes, which is formed on one of the hub-side wall surface or the shroud-side wall surface, is joined to the other one of the hub-side wall surface or the shroud-side wall surface. After the joining step, in the fitting step, the annular member is fitted to the return channel.

### Advantageous Effects of Invention

According to the present invention, it is possible to improve the tangential velocity component removal ability of front and rear vanes provided in the return channel of a centrifugal compressor.

### BRIEF DESCRIPTION OF DRAWINGS

FIG. 1 is an axial sectional view of a centrifugal compressor according to a first embodiment.

FIG. 2 is an enlarged sectional view of Area A of FIG. 1.

FIG. 3 is a flowchart showing a method for manufacturing a return vane structure of the first embodiment.

FIG. 4 is a perspective view of an annular member and a shroud-side structure that are temporarily joined.

FIG. 5 is a perspective view of the annular member and the shroud-side structure with front and rear vanes respectively formed thereon.

FIG. 6 is a perspective view of the shroud-side structure with the rear vanes formed thereon.

FIG. 7 is a perspective view of the annular member with the front vanes formed thereon.

FIG. 8 is a perspective view of a structure obtained by joining the rear vanes formed on the shroud-side structure to a hub-side structure.

FIG. 9 is a perspective view of a structure obtained by splitting the structure shown in FIG. 7 into halves and fitting the halves to the structure shown in FIG. 8 from radially outside.

FIG. 10 is an enlarged sectional view of the return vane structure of the first embodiment.

FIG. 11 is an enlarged sectional view of a return vane structure of a second embodiment.

FIG. 12 is a flowchart showing a method for manufacturing the return vane structure of the second embodiment.

### DESCRIPTION OF EMBODIMENTS

Hereinafter, embodiments of the present invention will be described in detail with reference to the accompanying drawings.

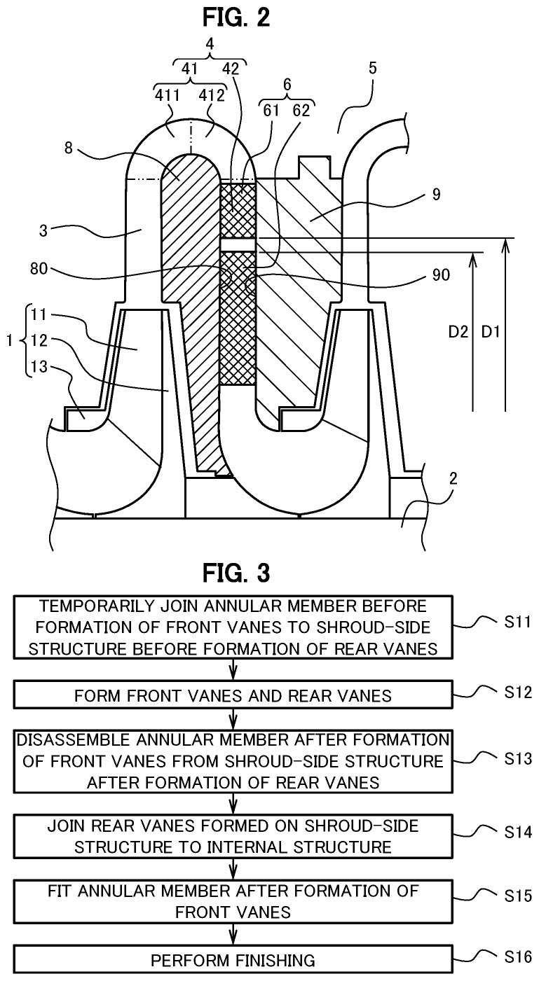

In the following drawings, identical or corresponding members are denoted by the same reference numerals, and the redundant description thereof is properly omitted. Some members are schematically illustrated with the size and shape deformed or exaggerated for convenience of explanation. For example, in FIG. 2, the gap between front and rear vanes is shown in a different scale from the actual one for convenience of explanation.

### First Embodiment

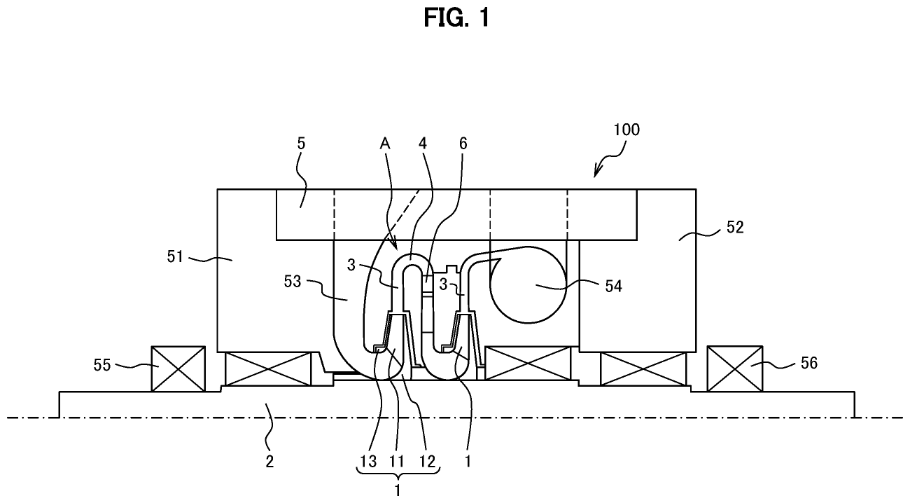

FIG. 1 is an axial sectional view (a sectional view along a meridian plane) of a centrifugal compressor 100 according to a first embodiment of the present invention. Herein, the axial section (the section along a meridian plane) is a sectional plane of the centrifugal compressor 100 including a central axis of a rotation shaft 2, on which components are projected. FIG. 1 shows only the upper half of the centrifugal compressor 100.

As shown in FIG. 1, the centrifugal compressor 100 includes plural centrifugal impellers 1, the rotation shaft 2, diffusers 3, and a return channel 4. The centrifugal impellers 1 rotate to give energy to fluid. The centrifugal impellers 1 are mounted on the rotation shaft 2. FIG. 1 shows only two centrifugal impellers by way of example. The diffusers 3 are provided radially outside of the respective centrifugal impellers 1. The diffusers 3 cause fluid exiting the respective centrifugal impellers 1 to flow in the centrifugal direction from the rotation shaft 2. Each diffuser 3 converts kinetic pressure of the fluid exiting the centrifugal impeller 1 into static pressure. The return channel 4 is provided downstream of the corresponding diffuser 3 and guides the fluid to the centrifugal impeller 1 of the subsequent stage. Specifically, the return channel 4 causes the fluid flowing from the diffuser 3 to the centrifugal impeller 1 of the subsequent stage to flow in a return direction toward the rotation shaft 2.

Each centrifugal impeller 1 includes plural blades 11, which are arranged at intervals in the circumferential direction. The blades 11 are typically positioned between a hub (a disk) 12, which is fastened to the rotation shaft 2, and a shroud (a side plate) 13, which is arranged facing the hub 12. Each centrifugal impeller 1 shown in the first embodiment is a closed centrifugal impeller example including the shroud 13. Each centrifugal impeller 1 may be an open centrifugal impeller not including the shroud 13.

Each diffuser 3 is a vaneless diffuser not including a vane in the first embodiment. Each diffuser 3 may be a vaned diffuser including plural vanes arranged at a substantially equal pitch in the circumferential direction.

The return channel 4 has a role in removing tangential velocity components of fluid flowing through the return channel 4 to straighten the flow while causing the fluid to flow to the centrifugal impeller 1 of the next stage. The return channel 4 includes plural return vanes 6. The return vanes 6 are arranged at a substantially equal pitch in the circumferential direction around the central axis of the rotation shaft 2. The detail thereof is described later.

The centrifugal impellers 1, rotation shaft 2, diffusers 3, and return channel 4 are accommodated in a casing 5. The casing 5 is supported by flanges 51 and 52. On the fluid suction side of the casing 5, a suction channel 53 is provided. On the fluid discharge side of the casing 5, a discharge channel 54 is provided.

The centrifugal compressor 100 includes radial bearings 55 and 56 on respective ends of the rotation shaft 2. The radial bearings 55 and 56 rotationally support the rotation shaft 2.

In the thus-configured centrifugal compressor 100, fluid suctioned through the suction channel 53 increases in pressure each time the fluid passes through the centrifugal impeller 1, diffuser 3, and return channel 4 of each stage and finally reaches a predetermined pressure to be discharged from the discharge channel 54.

FIG. 2 is an enlarged sectional view of Area A of FIG. 1. The return channel 4 includes a return bend portion 41 and a return vane portion 42. The return bend portion 41 includes a first redirection portion 411 and a second redirection portion 412. In the first redirection portion 411, the fluid having flowed through the diffuser 3 is then redirected from the radially outward direction to the axial direction. In the second redirection portion 412, the fluid having flowed through the first redirection portion 411 is further redirected from the axial direction to the radially inward direction. The return vane portion 42 is a channel provided with the return vanes 6.

The return channel 4 is provided between a hub-side wall surface 80 and a shroud-side wall surface 90. The shroud-side wall surface 90 is a wall surface within the return channel 4 on the side where fluid having passed on the shroud 13 side of the centrifugal impeller 1 mainly flows. The shroud-side wall surface 90 includes a portion of wall surface on the right side in FIG. 2 in the return vane portion 42, corresponding to the surface of an external structure 9, which is fixed to the casing 5. The hub-side wall surface 80 is a wall surface within the return channel 4 on the side where fluid having passed on the hub 12 side of the centrifugal impeller 1 mainly flows. The hub-side wall surface 80 includes a portion of wall surface on the left side in FIG. 2 in the return vane portion 42, corresponding to the surface of an internal structure 8, which is fixed to the external structure 9 through the return vanes 6.

The return vanes 6 include front vanes 61 and rear vanes 62. In the first embodiment, the return vanes 6 are tandem return vanes. The rear vanes 62 are provided downstream of the front vanes 61. In the return vane portion 42 of the return channel 4, the front vanes 61 are arranged in a circular array on the upstream side while the rear vanes 62 are arranged in a circular array on the downstream side (see FIG. 5).

In the first embodiment, the front vanes 61 and the rear vanes 62 have a relationship of: innermost diameter D1 of the front vanes 61>outermost diameter D2 of the rear vanes 62. The gap provided between the front vanes 61 and the rear vanes 62 in the radial direction is designed to be small in order to improve the tangential velocity component removal ability.

FIG. 3 is a flowchart showing a method for manufacturing the return vane structure of the first embodiment.

Hereinafter, the method for manufacturing the return vane structure will be described in the order shown in the flowchart of FIG. 3.

First, an annular member 92, on which the front vanes 61 (see FIG. 5) are not yet formed (before formation of front vanes), and a shroud-side structure 91, on which the rear vanes 62 (see FIG. 5) are not yet formed (before formation of rear vanes), are temporarily Mined (S11).

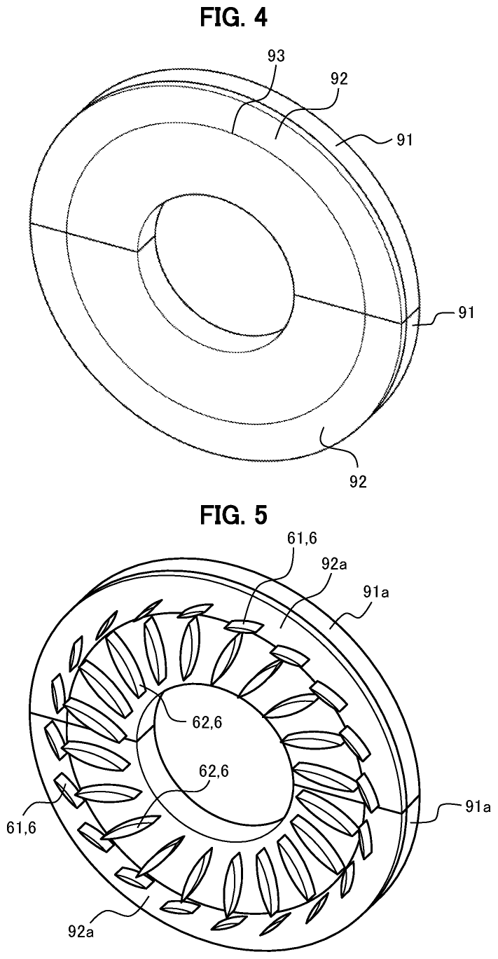

FIG. 4 is a perspective view of the annular member 92 before formation of front vanes and the shroud-side structure 91 before formation of rear vanes that are temporarily joined.

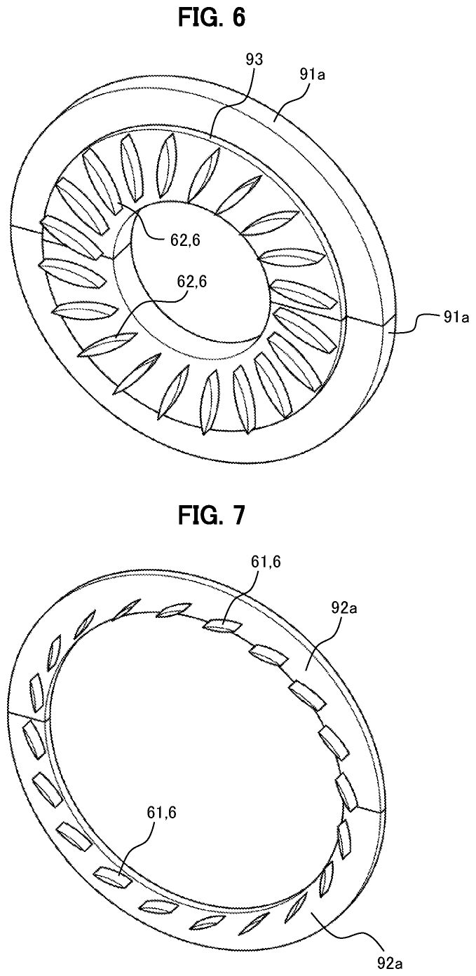

The annular member 92 before formation of front vanes and the shroud-side structure 91 before formation of rear vanes are each composed of an annular metallic material. In the return channel 4 side of the shroud-side structure 91, a small-diameter portion 93 (also see FIG. 6) is provided. The small-diameter portion 93 has an outer diameter smaller than part of the shroud-side structure 91 on the side opposite to the return channel 4. The annular member 92 before formation of front vanes and the shroud-side structure 91 before formation of rear vanes are positioned concentrically and are temporarily joined. Herein, the annular member 92 is located radially outside of the small-diameter portion 93 of the shroud-side structure 91. The positioning and temporary joining processes are performed using a fastening member (not shown), such as a bolt or a dowel pin for general use, that extends radially from the outside toward the inside and can be subsequently unfastened. The fastening member is positioned so as not to interfere with a tool at forming the front and rear vanes 61 and 62 in a subsequent process. The relative positions of the annular member 92 before formation of front vanes to the shroud-side structure 91 before formation of rear vanes is thus prevented from moving.

The annular member 92 before formation of front vanes and the shroud-side structure 91 before formation of rear vanes each have a half-split structure. At forming the front and rear vanes 61 and 62 in a subsequent process, the annular member 92 before formation of front vanes and the shroud-side structure 91 before formation of rear vanes are fixed to each other with a jig or the like so as to maintain the state shown in FIG. 4.

Next, a formation step of forming the front vanes 61 and the rear vanes 62 is performed (S12).

FIG. 5 is a perspective view of an annular member 92a and a shroud-side structure 91a with the front vanes 61 and the rear vanes 62 respectively formed thereon.

As shown in FIG. 5, the front vanes 61 and the rear vanes 62 are formed in the structure shown in FIG. 4. The formation process herein is machining, such as cutting, for example. This ensures the relative position of the front vanes 61 to the rear vanes 62 with a processing accuracy of a typical processing machine.

Next, the annular member 92a after formation of front vanes and the shroud-side structure 91a after formation of rear vanes are disassembled from each other (S13).

FIG. 6 is a perspective view of the shroud-side structure 91a with the rear vanes 62 formed thereon. FIG. 7 is a perspective view of the annular member 92a with the front vanes 61 formed thereon. The disassembling process is performed by unfastening the fastening member (not shown), such as a bolt or a dowel pin.

Next, a joining step of joining the rear vanes 62 formed on the shroud-side structure 91a to the internal structure 8 is performed (S14).

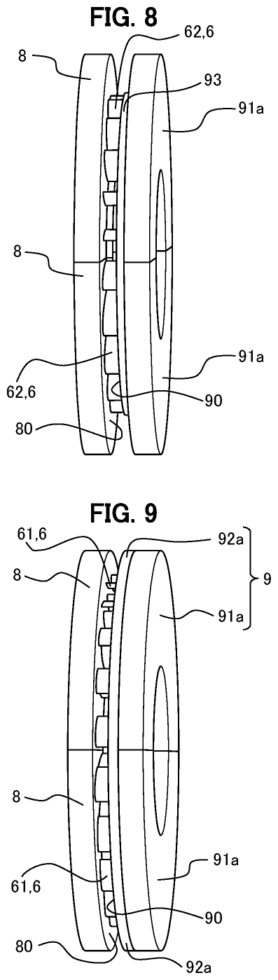

FIG. 8 is a perspective view of a structure obtained by joining the rear vanes 62 formed on the shroud-side structure 91a to the internal structure 8. The rear vanes 62 of the structure shown in FIG. 6 and the internal structure 8 are joined by a joining process, such as welding.

In this joining process, the return vanes 6 as the tandem return vanes can be joined to the internal structure 8 equally to joining of single-array return vanes to the internal structure S. It is therefore possible to ease the limiting condition for the gap between the front vanes 61 and the rear vanes 62 concerning the manufacturability of the tandem return vanes.

Next, a fitting step of fitting the annular member 92a after formation of front vanes, to the structure shown in FIG. 8 (S15).

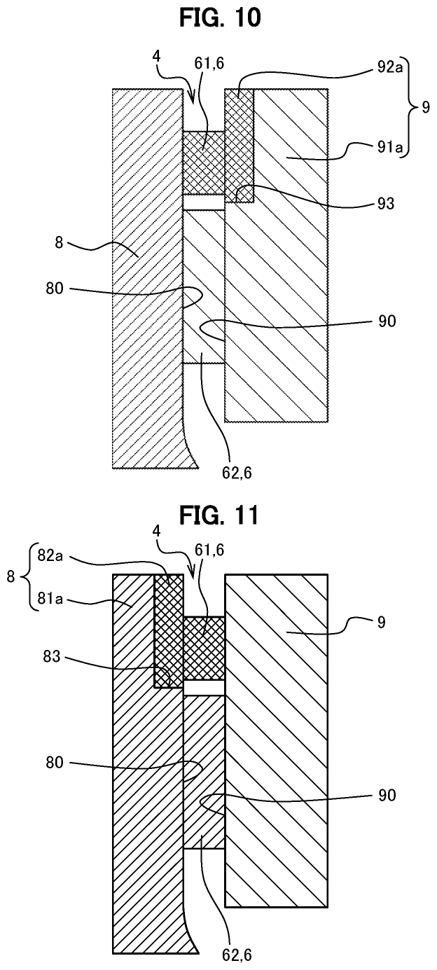

FIG. 9 is a perspective view of a structure obtained by splitting the structure shown in FIG. 7 into halves and fitting the halves to the structure shown in FIG. 8 from radially outside. FIG. 10 is an enlarged sectional view of the return bane structure of the first embodiment. FIG. 10 is an axial sectional view (a sectional view along a meridian plane) of the structure shown in FIG. 9. FIG. 10 shows only the upper half (Area A in FIG. 1). The fitting process is performed using a fastening member (not shown), such as a bolt or a dowel pin. In the first embodiment, the annular member 92a and the shroud-side structure 91a constitute the external structure 9.

The internal structure 8 is fixed to the external structure 9 through the rear vanes 62 and is not joined to the front vanes 61.

Next, the structure shown in FIGS. 9 and 10 is subjected to finishing (S16).

Thus, the return vane structure including the front vanes 61, rear vanes 62, internal structure 8, and external structure 9 is formed as shown in FIG. 2.

In the first embodiment, as described above, the front vanes 61 are formed on the annular member 92a, which is formed separately from the rear vanes 62, in the formation step (S12). In the joining step (S14), the rear vanes 62 formed on the shroud-side wall surface 90 are joined to the hub-side wall surface 80. After the joining step (S14), the annular member 92a is fitted to the return channel 4 in the fitting step (S15).

In the case of mounting the return vane structure in the casing 5, the split halves of the return vane structure are built in and fixed to respective split halves of the casing 5. The split halves of the casing 5 with the split halves of the return vane structure built therein are then integrated by being joined to each other.

As described above, in the centrifugal compressor 100 according to the first embodiment, the return channel 4 is provided between the hub-side wall surface 80 and the shroud-side wall surface 90. The return channel 4 includes the front vanes 61, which are arranged in a circular array on the upstream side, and the rear vanes 62, which are arranged in a circular array on the downstream side. The array of front vanes 61 and the array of rear vanes 62 are both formed on the shroud-side wall surface 90. The front vanes 61 are formed on the annular member 92a, which is formed separately from the rear vanes 62. The annular member 92a is fitted to the return channel 4.

In the thus-configured first embodiment, as shown in FIG. the front vanes 61 are formed on the annular member 92a, which is formed separately from the rear vanes 62, and the annular member 92a is fitted to the return channel 4. The joining process for the tandem return vanes, for example, which include the front vanes 61 and rear vanes 62, can be performed equally to joining of the single-array return vanes. That is, any situation does not occur in which the joining operation is complicated because the welding rod cannot easily reach between the front vanes 61 and rear vanes 62 through gaps in the outer or inner circumference when the hub-side wall surface 80 and the shroud-side wall surface 90 face each other with the front and rear vanes 61 and 62 interposed therebetween. It is therefore possible to ease the limiting condition for the gap between the front vanes 61 and the rear vanes 62 concerning the manufacturability of the tandem return vanes, for example. The gap between the front vanes 61 and the rear vanes 62 therefore can be configured to be small in order to improve the tangential velocity component removal ability.

It is therefore possible to provide a structure including tandem return vanes that facilitates joining the vanes without limiting the shape of the front and rear vanes 61 and 62 in particular. Improved interaction between the front and rear vanes 61 and 62, which is important to the tandem return vanes, for example, enhances the ability to remove tangential velocity components of the fluid.

According to the first embodiment, as described above, it is possible to improve the tangential velocity component removal ability of the front and rear vanes 61 and 62, which are provided in the return channel 4 of the centrifugal compressor 100.

In the first embodiment, furthermore, the vanes not formed on the annular member 92a are formed by direct processing for the wall surface of the return channel 4. With this configuration, the return vane structure including the front and rear vanes 61 and 62 can be easily formed by fitting the annular member 92a, as a different body, with the vanes formed thereon to the return channel 4.

In the first embodiment, the front vanes 61 are formed on the annular member 92a, and the rear vanes 62 are formed by direct processing for the wall surface of the return channel 4. In this configuration, the annular member 92a with the front banes 61 formed thereon can be easily fitted to the return channel 4 from radially outside.

In the first embodiment, the innermost diameter D1 of the front vanes 61 is greater than the outermost diameter D2 of the rear vanes 62. In this configuration, the inner surface of the annular member 92a is configured to be a cylindrical surface. The annular member 92a therefore has a simple structure and can be easily fitted to the return channel 4.

### Second Embodiment

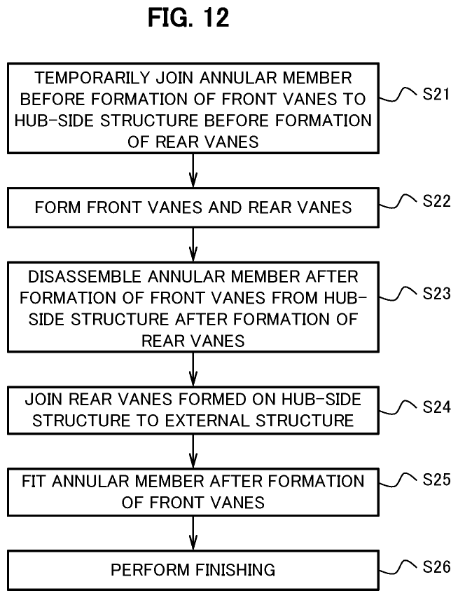

With reference to FIGS. 11 and 12, a second embodiment of the present invention will be described, focusing on different points from the aforementioned first embodiment. The description of the same points is omitted properly.

FIG. 11 is an enlarged sectional view of a return vane structure of the second embodiment. FIG. 11 shows only the upper half (Area A in FIG. 1).

As shown in FIG. 11, the second embodiment is different from the first embodiment in that the array of front vanes 61 and the array of rear vanes 62 are both formed on the hub-side wall surface 80. The front vanes 61 are formed on an annular member 82a, which is formed separately from the rear vanes 62. The annular member S2a is fitted to the return channel 4. Specifically, the annular member 82a is arranged and fitted radially outside of a small-diameter portion 83, which is provided in the return channel 4 side of a hub-side structure 81a.

FIG. 12 is a flowchart showing a method for manufacturing the return vane structure of the second embodiment. Hereinafter, with reference to FIG. 11, the method for manufacturing the return vane structure will be described in the order shown in the flowchart of FIG. 12.

First, an annular member (not shown) on which the front vanes 61 are not yet formed (before formation of front vanes) and a hub-side structure on which the rear vanes 62 are not yet formed (before formation of rear vanes) are temporarily joined (S21).

Next, a formation step of forming the front vanes 61 and the rear vanes 62 is performed (S22). In the formation step (S22), the front vanes 61 are formed on the annular member 82a, which is formed separately from the rear vanes 62.

Next, the annular member 82a after formation of front vanes and the hub-side structure 81a after formation of rear vanes are disassembled from each other (S23).

Next, a joining step of joining the rear vanes 62 formed on the hub-side structure 81a to the external structure 9 is performed (S24). In the joining step (S24), the rear vanes 62 formed on the hub-side wall surface 80 are joined to the shroud-side wall surface 90.

Next, a fitting step of fitting the annular member 82a after formation of front vanes is performed (S25). Specifically, after the joining step (S24), the annular member 82a is fitted to the return channel 4 in the fitting step (S25). In the second embodiment, the annular member 82a and the hub-side structure 81a constitute the internal structure 8.

Next, finishing is performed (S26).

Thus, the return vane structure including the front vanes 61, rear vanes 62, internal structure 8, and external structure 9 is formed as shown in FIG. 2.

According to the second embodiment, similarly to the first embodiment, it is possible to improve the tangential velocity component removal ability of the front and rear vanes 61 and 62, which are provided for the return channel 4 of the centrifugal compressor 100.

Hereinabove, the present invention is described based on the embodiments. However, the present invention is not limited to the aforementioned embodiments and include various modifications. For example, the aforementioned embodiments are described in detail for easy understanding of the present invention and are not always limited to ones including all the configurations described above. Part of the configuration of any one of the embodiments can be substituted with the corresponding configuration of the other embodiment, and the configuration of any one of the embodiments can be added with the configuration of the other embodiment. Part of the configuration of each embodiment can be added or substituted with another configuration or can be deleted.

For example, in the aforementioned embodiments, the front vanes 61 are formed on the annular member 92a or 82a, and the rear vanes 62 are formed by direct processing for the wall surface of the return channel 4. However, the present invention is not limited thereto. The rear vanes 62 may be formed on the annular member (not shown) while the front vanes 61 are formed by direct processing for the wall surface of the return channel 4.

In the aforementioned embodiments, the return vanes 6, which are provided for the return channel 4, are tandem return vanes including the front and rear vanes 61 and 62. However, the present invention is not limited thereto. For example, the return channel 4 may be provided with three circular arrays of vanes arranged from upstream to downstream. In this case, two of the three arrays of vanes that are radially adjacent to each other correspond to the front and rear vanes of the present invention.

### REFERENCE SIGNS LIST

1 CENTRIFUGAL IMPELLER
2 ROTATION SHAFT
3 DIFFUSER
4 RETURN CHANNEL
6 RETURN VANE
61 FRONT VANE
62 REAR VANE
80 HUB-SIDE WALL SURFACE
82a, 92a ANNULAR MEMBER
90 SHROUD-SIDE WALL SURFACE
100 CENTRIFUGAL COMPRESSOR
D1 INNERMOST DIAMETER OF FRONT VANES
D2 OUTERMOST DIAMETER OF REAR VANES

1.-5. (canceled)

6. A centrifugal compressor, comprising:
a rotation shaft;
a plurality of centrifugal impellers mounted on the rotation shaft;
a diffuser causing fluid exiting one of the centrifugal impellers to flow in a centrifugal direction from the rotation shaft; and
a return channel that is provided downstream of the diffuser and causes the fluid flowing from the diffuser to the centrifugal impeller of a subsequent stage to flow in a return direction toward the rotation shaft, wherein
the return channel is provided between a hub-side wall surface and a shroud-side wall surface,
the return channel includes a front set of vanes arranged in a circular array on an upstream side and a rear set of vanes arranged in a circular array on a downstream side,
the front set of vanes and the rear set of vanes are both formed on one of the hub-side wall surface or the shroud-side wall surface,
one of the front set of vanes or the rear set of vanes is formed on an annular member that is formed separately from the other one of the front set of vanes or the rear set of vanes,
the other one of the front set of vanes or the rear set of vanes is formed by direct processing for the wall surface of the return channel, and joined to the other one of the hub-side wall surface or the shroud-side wall surface by welding; and
the annular member is fitted to the return channel.

7. The centrifugal compressor according to claim 6, wherein
the front set of vanes is formed on the annular member, and
the rear set of vanes is formed by direct processing for the wall surface of the return channel.

8. The centrifugal compressor according to claim 6, wherein the innermost diameter of the front set of vanes is greater than the outermost diameter of the rear set of vanes.

9. A method for manufacturing a centrifugal compressor, comprising:
a formation step of forming one of a front set of vanes or a rear set of vanes on an annular member formed separately from the other one of the front set of vanes or the rear set of vanes, the front set of vanes being arranged in a circular array on an upstream side in a return channel provided between a hub-side wall surface and a shroud-side wall surface, the rear set of vanes being arranged in a circular array on a downstream side;
a joining step of joining the other one of the front set of vanes or the rear set of vanes, which is formed on one of the hub-side wall surface or the shroud-side wall surface by direct processing for the wall surface of the return channel, to the other one of the hub-side wall surface or the shroud-side wall surface by welding; and
a fitting step of after the joining step, fitting the annular member to the return channel.
